(19) United States
(12) Patent Application Publication
(10) Pub. No.: US 2009/0175153 A1
(43) Pub. Date: Jul. 9, 2009

(54) Electrical-Effect Data Recording Medium that Includes a Localized Electrical Conduction Layer

(75) Inventors: Serge Gidon, La Murette (FR); Yohan Desieres, Grenoble (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 12/226,985

(22) PCT Filed: May 3, 2007
(86) PCT No.: PCT/FR2007/000760

§ 371 Date: Nov. 4, 2008

(30) Foreign Application Priority Data
May 18, 2006 (FR) 0604458

(51) Int. Cl. G11B 9/00

(52) U.S. Cl. 369/126; G9B/9

(57) ABSTRACT

An electrical-effect data recording medium is preferably formed by a successive stacking of a protective layer, a localized electrical conduction layer, a recording layer, a thin layer forming an electrode and a substrate. The localized electrical conduction layer is formed by a low electrical conductivity material, in which inclusions having a higher electrical conductivity than that of the material are dispersed. The inclusions can be oblong or spherical in shape and the material presents a non-linear electrical conduction.

### BACKGROUND OF THE INVENTION

The invention relates to a medium for recording data by electrical effect comprising at least a recording layer whereon there is arranged a localized electrical conduction layer formed by a material presenting a low electrical conductivity and wherein inclusions presenting a higher electrical conductivity than that of said material are dispersed.

### STATE OF THE ART

Data recording, in both the computer and multimedia fields, has to meet an increasing requirement for capacity. Different techniques have been developed ranging from the magnetic hard disk to the recording medium using optics (of DVD type for example) and solid memories. Whatever the recording technique used, the size of the memory dots (bits) is always sought to be reduced. Increasing the recording capacity means increasing the storage density. But the means of accessing the recorded data often fix the maximum possible storage density: for example the size of the laser spot in optics or the line/column addressing circuit for solid memories.

Recently, very large storage capacities of about one Terabit/cm² have been obtained by implementing microtips of the same type as those used in the field of atomic force microscopy (“The Millipede—More than one thousand tips for future AFM data storage”, P. Vettiger et al., IBM J. RES. Develop., vol. 44, no 3, May 2000, p. 323-340). High density is obtained by localizing the bits by means of microtips with an apex of nanometric dimension. Generally, a plurality of microtips is used, in quasi-contact with the surface of the recording medium, to locally modify the properties of said medium and to therefore encode data before being able to read it back.

Recording media can be sorted into different families depending on the type of properties modified in the medium when recording of the data takes place. Data recording can therefore be achieved by forming holes in a layer of polymer material or by reversible change from an amorphous state to a crystalline state in a phase change material or by magnetic or optic effects.

Data recording is also performed by displacement of electrically charged species (electrons, ions) or of a current from a microtip through the recording medium. Such a technique also enables bits presenting a very good spatial resolution to be obtained.

S. Gidon et al., in the article “Electrical probe storage using Joule heating in phase change media” (Applied Physics Letters, Vol. 85, No 26, 27/12/2004, pages 6392-6394) studied data recording performed by means of microtips in a recording medium by phase change. The recording medium is formed by a stack successively comprising a silicon substrate, a carbon electrode, a Ge₂Sb₂Te₅ recording layer and a carbon protective layer. Recording is achieved by heating an area of the recording layer by Joule effect. Said area is in fact designated by a microtip electrically polarized so that a current flows through the medium, which enables a mark with a dimension of 15 nm to be obtained.

However, the performance of such recording media results from the fact that the recording layer is designated, in near field, by microtips. The protective layer or layers arranged between the microtips and the recording layer, in particular to protect the medium against friction of the microtips, have to be as thin as possible so as not to reduce the spatial resolution. This constraint is not however compatible with long lifetime of recording media, all the more so as the protective layers are often subjected to large stresses such as heating caused by flow of the current or effects linked to the surface electric field.

In Patent application EP-A-0739004, the recording medium does not comprise a protective layer. Data recording is performed by modifying the conduction of the recording medium locally, under an electric field. This modification is achieved by breakdown of a silicon oxide insulating layer formed on a p- or n-doped silicon substrate and used as recording layer. Applying a voltage between a microtip placed on the same side as the insulating layer and said substrate in fact creates a current flux of Fowler-Nordheim type that causes a local decrease of the resistance of the insulating layer. This local decrease of the resistance of the insulating layer is thereby used to record data in the insulating layer. However, the absence of a protective layer makes this type of recording medium extremely fragile.

In the document US2005/0285169, the hysteretic material memory layer of a memory matrix is covered by a conducting layer that is electrically anisotropic. The conducting layer is formed by a method enabling a molecular structure to be obtained containing pass-through conducting dots insulated from one another by a matrix of lower conductivity. The molecular structures used are for example metallic clusters, grains in the form of columns, granular films, fullerenes, nanoparticles, etc. In the document US2005/0285169, the conducting layer with its conducting dots enables the multilayer masked structures designed to delineate the ferroelectric cells from the ferroelectric random-access memories (FeRAM) to be replaced.

In Patent application GB1088117, a moving data recording medium by electric effect comprises an electrically conducting substrate on which there is deposited a molybdenum disulphide film able to be selectively and reversibly changed from a high impedance state to a low impedance state by a controlled electric current applied between an electrode tip and the conducting substrate. The molybdenum disulphide film can be covered by another film, etched in the form of a plurality of conducting portions, the spaces between the contacts being filled with an insulating material. Data recording and erasure are thereby performed in the areas of the molybdenum disulphide film located directly under the conducting portions. Such a film is not however easy to implement and does not enable precise recording of data.

### OBJECT OF THE INVENTION

The object of the invention is to remedy the shortcomings of the prior art. More particularly, the object of the invention is to propose a data recording medium by electrical effect presenting high data storage capacities.

According to the invention, this object is achieved by the appended claims.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIGS. 1 and 2 schematically represent a first embodiment of a recording medium according to the invention, in cross-section, respectively before and after data recording.

FIG. 3 schematically represents a second embodiment of a recording medium according to the invention, in cross-section.

FIG. 4 schematically represents an alternative embodiment of a recording medium according to FIG. 3, in cross-section.

FIG. 5 represents a third embodiment of a recording medium according to the invention, in cross-section.

### DESCRIPTION OF PARTICULAR EMBODIMENTS

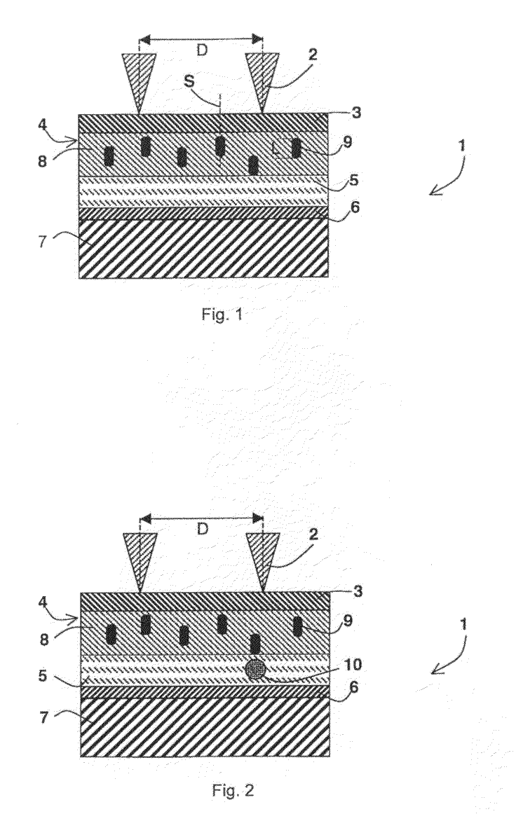

According to a first embodiment illustrated in FIGS. 1 and 2, an electrical-effect data recording medium 1, used for example in a recording device by microtips 2, is formed by a successive stack of preferably flat thin layers.

What is meant by electrical-effect data recording medium 1 is a recording medium able to use charge storage effects, charged species (ions, cations) migration effects or sub-field conduction effects. This can cause a localized modification of the local electrical conductivity in the recording layer or memory layer of the medium, for example by breakdown or by current flow. The electrical effect can also be considered as a field effect inducing a concentration of the current lines in a more or less conducting recording layer. In this case, the write process can be based on a thermal effect in a recording layer with phase change or on an electrolytic effect or on any other effect leading to displacements of charged species.

In a recording device by microtips 2, a voltage is applied between at least one microtip 2 and an electrode arranged under the recording layer in such a way as to generally modify the electrical conduction of the recording layer locally.

Thus, in FIGS. 1 and 2, the medium 1 is formed by successive superposition of a protective layer 3, a localized electrical conduction layer 4, a recording layer 5 or layer memory, a thin layer forming an electrode 6 and a substrate 7. Two microtips 2, separated by a distance D that is typically 100 μm, are arranged on the same side as protective layer 3 of medium 1, their free ends touching said protective layer 3.

Localized electrical conduction layer 4, arranged on recording layer 5, is a thin layer comprising localized areas having a higher electrical conduction than that of the rest of said thin layer 4. More particularly, thin layer 4 is formed by a low electrical conductivity material 8 in which inclusions 9 of higher electrical conductivity than that of material 8 are dispersed. Inclusions 9 thereby define the higher electrical conductivity areas. In FIGS. 1 and 2, inclusions 9 are oblong in shape and present a longitudinal axis S that is substantially perpendicular to the interface between localized electrical conduction layer 3 and recording layer 5. Inclusions 9 are for example formed by carbon nanotubes or n- or p-doped silicon nanotubes, doping making the silicon conducting. Material 8 of localized electrical conduction layer 4 is further chosen to present a non-linear electrical conductivity, i.e. an electrical conduction that is variable according to the electric field to which material 8 is subjected. Material 8 is for example a chalcogenide-base compound presenting an electrical conductivity that increases with the applied electric field, such as GeSbTe, AgInSbTe. Material 8 can also be a telluride, a selenide, a sulphide such as FeSi₂ or hydrogenated amorphous silicon.

The presence of a localized electrical conduction layer 4 on recording layer 5, and more particularly between recording layer 5 and microtips 2, protects recording layer mechanically, in particular against friction caused by microtips 2 but also against any mechanical compression stresses resulting from contact of the microtips on the recording device.

Furthermore, arranging a localized electrical conduction layer 4 on recording layer 5 means that the electric field effect is focused, enabling not only large storage capacities to be obtained while preserving a good spatial resolution but also the energy required for recording said data to be reduced by localizing the electrical effect very finely. The presence of localized areas with a high electrical conductivity, such as inclusions 9, in fact takes advantage of an electrical effect, in medium 1, amplified by the form factor of the volume of said area and more particularly of the volume of inclusion 9. An inclusion 9 of oblong shape thereby leads, when a microtip 2 is located near said inclusion 9, to prolonging the tip effect in localized electrical conduction layer 4, before reaching recording layer 5 in which marks will be formed. Prolonging the tip effect in localized electrical conduction layer 4 can occur by electrical influence or by conduction by proximity of dots, conduction by proximity of dots being equivalent to a conduction of jump conduction type in a medium that is not very conducting. Thus, in FIG. 2, a mark (bits) 10 has been recorded in recording layer 5 respectively facing inclusions 9 closest to the microtip bearing the reference 2.

More particularly, numerical modelling of the electric field near an inclusion 9 such as the one represented in FIG. 1, under the influence of a polarized microtip 2, enables the following to be determined:
an optimal ratio of about 3 between the thickness of localized electrical conduction layer 4 and that of recording layer 5
and an optimal ratio of about ⅓ between the electrical resistivity of localized electrical conduction layer 4 and that of recording layer 5.

The thicknesses of layers 4 and 5 range from a few nanometers to a few tens of nanometers. For example, the thickness of localized electrical conduction layer 4 may reach a value of 50 nm.

Furthermore, the fact that material 8 presents a non-linear electrical conductivity presents the advantage of obtaining a caisson effect when an electrical field is applied between a microtip 2 and an electrode 6. A material with non-linear electrical conduction does in fact enable the electrical field to be directed onto the inclusion 9 that is closest to said microtip 2. This means that a single mark is created in recording layer 5, said mark being located substantially under the corresponding inclusion 9. On the contrary, with a material with linear electrical conduction, applying an electrical field near several inclusions leads to several marks being formed in the recording layer. This feature of material 8, combined with the oblong shape of the inclusions, is particularly advantageous in so far as the recording medium benefits from a double focusing effect of the field lines, on account of the oblong shape of the inclusions and of the non-linear conduction property of material 8.

Advantageously and as represented in FIGS. 1 and 2, inclusions 9 are not pass-through, i.e. they do not pass right through localized conduction layer 4 in the direction of its thickness. More particularly, in FIGS. 1 and 2, the maximum dimension L of oblong inclusions 9 is smaller than the thickness of localized conduction layer 4, so that no inclusion is both in contact with the interface between localized conduction layer 4 and protective layer 3 and in contact with the interface between localized conduction layer 4 and recording layer 5. This notably facilitates formation of localized conduction layer 4, in so far as material 8 can be deposited in known manner, for example by encapsulating inclusions 9.

For example, a recording medium 1 such as the one represented in FIG. 1 is obtained by successively performing on substrate 7:

a) deposition of the thin layer forming electrode 6, for example by physical vapor deposition (PVD) of amorphous carbon that may be charged by adding metallic inclusions (for example made of gold or silver) designed to increase the electrical conductivity of the thin layer, either in the target or by co-sputtering,
b) deposition of recording layer 5, for example by PVD or by chemical vapor deposition (CVD) or by vacuum evaporation. Recording layer 5 is for example formed by a quasi-insulating material that is able to break down by electric field effect, such a material being for example silica or alumina with a thickness of the thin layer of less than 2 nm. Recording layer 5 can also be formed by a low electrical conductivity material the value whereof is modified by localized current flow, such as carbon charged with impurities that are able to coalesce when an electrical effect takes place and therefore to locally modify the electrical conductivity of the layer,
c) growth of nanotubes forming inclusions 9, for example carbon nanotubes, using for example the method described by M. Chhowalla et al. in the article “Growth process conditions of vertically aligned carbon nanotubes using plasma enhanced chemical vapor deposition” (Journal of Applied Physics, Vol. 90, No 10, 15/11/2001, pages 5308-5316),
d) deposition of a material 8 with non-linear electrical conductivity so as to form localized electrical conduction layer 4 covering the carbon nanotubes.
e) planarization of localized electrical conduction layer 4, for example by chemical mechanical polishing (CMP), so as to control the thickness of layer 4 and more particularly the height of inclusions 9,
f) deposition of protective layer 3, for example achieved by PVD deposition of carbon that may be charged by metallic inclusions enabling a good electrical conductivity to be obtained.

Such a method for producing recording medium 1 enables the thickness of recording layer 5 to be controlled precisely. This is particularly important in that the latter has to be very small to enable a large electrical field to develop. The thickness of recording layer 5 is more particularly controlled as this layer is produced in the first steps of the method and deposition thereof can not tolerate any shape dispersions of the medium.

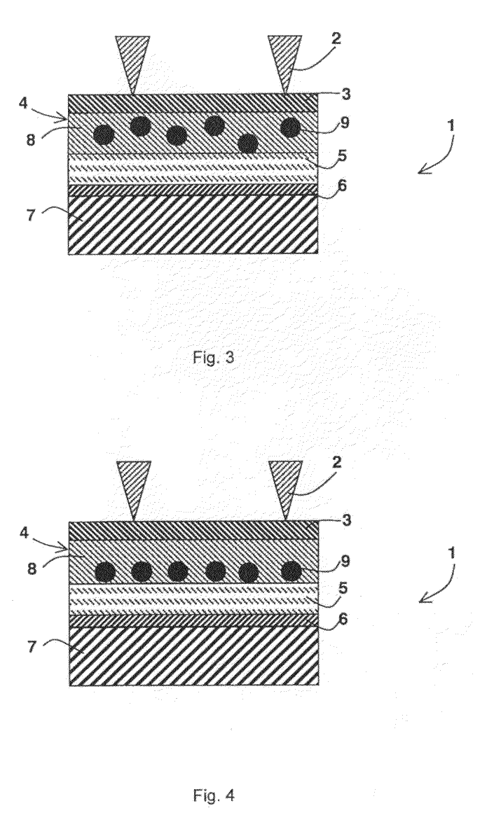

According to a second embodiment represented in FIG. 3, inclusions 9 of localized electrical conduction layer 4 are of substantially spherical shape. More particularly, inclusions 9 can be made of metal, for example chosen from nickel and iron, or they can be a compound chosen for example from nickel-, iron-, gold- or silver-base compounds, the gallium-arsenic compound and the aluminum-arsenic compound. The spherical inclusions thereby localize the action of the electric field applied from a microtip, near recording layer 5, by influence.

In the alternative embodiment represented in FIG. 4, inclusions 9 of spherical shape can be in contact with the interface between recording layer 5 and localized electrical conduction layer 4.

For example, the inclusions of spherical shape can be drops obtained by low-temperature dewetting of a metallic layer, for example made of nickel or iron, with a thickness of less than 10 nm previously deposited on recording layer 5. Inclusions of spherical shape 9 can also be obtained by etching a metallic layer through a mask. This mask can be a photolithographic mask or it can be obtained by a self-organization method such as the one described by K. W. Guarini et al. in the article “Process integration of self-assembled polymer templates into silicon nanofabrication” (J. Vac. Sci. Technol. B 20(6), November/December 2002, pages 2788-2792). Etching presents the advantage of being performed at ambient temperature, which allows phase change material to be used for recording layer 5.

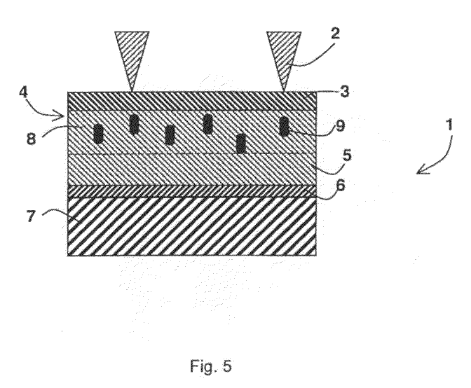

Likewise the material forming recording layer 5 can be identical to material 8 of localized electrical conduction layer 4, as represented in FIG. 5. This can for example be particularly interesting with a common chalcogenide-base material.

The invention is not limited to the embodiments described above. For example, the electrical-effect data recording medium can be a medium of memory solid type, electric memory with phase change type (Phase Change RAM or PCram), of CBram type (Conductive Bridge ram) or of solid WORM type (non-rewritable medium or media).

1. An electrical-effect data recording medium comprising at least a recording layer whereon there is arranged a localized electrical conduction layer formed by a material presenting a low electrical conductivity and wherein inclusions presenting a higher electrical conductivity than that of said material are dispersed, wherein the material presents a non-linear electrical conductivity.

2. The medium according to claim 1, wherein the inclusions are non pass-through.

3. The medium according to claim 1, wherein the inclusions are of oblong shape.

4. The medium according to claim 3, wherein each inclusion presents a longitudinal axis substantially perpendicular to the interface between the localized electrical conduction layer and the recording layer.

5. The medium according to claim 3, wherein the inclusions are carbon nanotubes or n- or p-doped silicon nanotubes.

6. The medium according to claim 1, wherein the inclusions are of substantially spherical shape.

7. The medium according to claim 6, wherein the inclusions are made from a metal selected from the group consisting of nickel and iron or made from a compound selected from the group consisting of gallium-arsenic compound, aluminum-arsenic compound, nickel-base compounds, iron-base compounds, gold-base compounds and silver-base compounds.

8. The medium according to claim 1, wherein that the material of the localized electrical conduction layer is a chalcogenide.

9. The medium according to claim 1, wherein the material forming the recording layer is identical to the material of the localized electrical conduction layer.

10. The medium according to claim 1, wherein the inclusions are in contact with the interface between the recording layer and the localized electrical conduction layer.

11. A method of protecting a recording layer of a medium according to claim 1, in a data recording device comprising at least one microtip comprising the step of; arranging the localized electrical conduction layer between the recording layer and the microtip.
